(19) United States
(12) Patent Application Publication
(10) Pub. No.: US 2024/0414721 A1
(43) Pub. Date: Dec. 12, 2024

(54) PHYSICAL DOWNLINK CONTROL CHANNEL (PDCCH) MONITORING

(71) Applicant: Telefonaktiebolaget LM Ericsson (publ), Stockholm (SE)

(72) Inventors: Ilmiawan SHUBHI, Malmö (SE); Ajit NIMBALKER, Dublin, CA (US); Ravikiran NORY, San Jose, CA (US)

(21) Appl. No.: 18/697,523

(22) PCT Filed: Oct. 3, 2022
(86) PCT No.: PCT/EP2022/077456

§ 371 Date: Apr. 1, 2024

Related U.S. Application Data
(60) Provisional application No. 63/251,451, filed on Oct. 1, 2021.

(51) Int. Cl. H04W 72/23; H04B 17/18; H04L 5/00

(52) U.S. Cl. CPC H04W 72/23; H04L 5/0053; H04B 17/18

(57) ABSTRACT

A method, system and apparatus for physical downlink control channel (PDCCH) monitoring adaptation in multicell operations are disclosed. According to one aspect, a method in a wireless device (WD) includes transmitting an intercell physical downlink control channel, PDCCH, monitoring adaptation indication capability information. The method also includes receiving a PDCCH monitoring adaptation configuration for a first configured cell and at least a second configured cell. The method further includes receiving an indication on the first configured cell indicating the WD to transit from a first PDCCH monitoring state to a second PDCCH monitoring state in at least the second configured cell. The method also includes transiting from the first PDCCH monitoring state to the second PDCCH monitoring state in at least the second configured cell.

### TECHNICAL FIELD

The present disclosure relates to wireless communications, and in particular to physical downlink control channel (PDCCH) monitoring adaptation in multicell operations. The present disclosure relates a method in a wireless device, a method in a network node, a wireless device and a network node.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. Sixth Generation (6G) wireless communication systems are also under development.

Wireless communication systems according to the 3GPP may include the following channels:
A physical downlink control channel, PDCCH;
A physical uplink control channel, PUCCH;
A physical downlink shared channel, PDSCH:
A physical uplink shared channel, PUSCH;
A physical broadcast channel, PBCH; and
A physical random access channel, PRACH.

Physical downlink control channel (PDCCH) monitoring in active time is one of the most power-consuming activities in a user equipment (UE). In fact, monitoring for PDCCH in the absence of data may be the dominant source of energy consumption in enhanced mobile broadband (eMBB) in typical scenarios. Considering this, techniques that can reduce unnecessary PDCCH MOs, i.e., allowing WD to go to sleep or wake-up only when required can be beneficial.

In 3GPP Technical Release 17 (3GPP Rel. 17) WD power-saving (UEPS) work item (WI), it has been considered that reducing unnecessary PDCCH monitoring can be done through either or both search-space set group (SSSG)-switching and PDCCH-skipping. For self-indication case (an indication received in a cell indicates the adaptation in that cell), it has been considered that at most 2 bits in the scheduling DCI can be used for the PDCCH monitoring adaptation.

In SSSG-switching, a WD can be configured with more than one (e.g., two) SSSGs and the WD can be indicated to switch between those SSSGs. Exploiting the SSSG-switching for WD power-saving can be done, for example by configuring the first SSSG (e.g., SSSG0) to have sparse PDCCH monitoring occasions (MOs) and the second SSSG (e.g., SSSG1) to have dense PDCCH MOs. The WD monitors PDCCH according to the first SSSG when there is no data burst and switch to SSSG1 when the data burst comes. The WD then can switch back to SSSG0 when the data burst ends.

In PDCCH-skipping, the WD is configured with one or more skipping durations. If the WD receives the skipping indication, the WD may skip PDCCH monitoring for the configured or indicated duration. When the skipping duration ends, the WD then goes back to monitor the PDCCH.

### SUMMARY

In a multicell scenario, except for self-indication, it may also be beneficial to have inter-cell indication, i.e., an adaptation indication in a cell can trigger an adaptation in other cells. For example, a cell in frequency range 1 (FR1) can be configured with a shorter skipping duration to minimize the throughput loss, i.e., the network (NW)/network node does not need to wait for a long time to reach the WD, and a cell in FR2 can be configured with a longer skipping duration to optimize the power saving. When the data comes, the cell in or using FR2 can be indicated to awake using an indication received in the cell in FR1.

For the case of PDCCH monitoring adaptation in multicell operation, several methods in handling the mechanism are possible, such as:
That an adaptation indication on one cell in one group of cell(s) may indicate the adaptation on other cells in the same group of cell(s);
That an indication in a first cell in the first group of cell(s) may indicate the adaptation on the cells in the second group of cell(s).

However, existing systems are not without issues. As an example, when an indication in a first cell inside a first group of cell(s) could trigger the adaptation in a second cell in the first group of cell(s), some problems may occur. For example, it is possible that the codepoints of the PDCCH monitoring adaptation bitfield in the first cell and the second cell represents different adaptation.

In another example, while a first cell in the first group of cell(s) may trigger adaptation of a second group of cell(s), only the case where the trigger affects all cells in the second group of cell(s) is discussed. Other mechanisms on the inter-cell adaptation indication which could give benefit for the power-saving mechanism are not described in existing systems.

Furthermore, detailed mechanisms on how a DCI should be configured (e.g., the number of bits available in the DCI may be limited) to handle the above scenarios and how those available bits could be used optimally also are not described in existing system.

The present invention is defined in the independent claims, to which reference is now directed. Further features are set out in the dependent claims.

According to a first aspect, there is a method implemented in a wireless device (WD). The method comprises transmitting an intercell physical downlink control channel, PDCCH, monitoring adaptation indication capability information. The method further comprises receiving a PDCCH monitoring adaptation configuration for a first configured cell and at least a second configured cell. The method further comprises: receiving an indication, in the first configured cell, indicating the WD to transit from a first PDCCH monitoring state to a second PDCCH monitoring state in at least the second configured cell; and responsive to the indication, transiting from the first PDCCH monitoring state to the second PDCCH monitoring state in at least the second configured cell.

According to a second aspect, there is a method implemented in a network node. The method comprises receiving an intercell physical downlink control channel, PDCCH, monitoring adaptation indication capability information from a wireless device, WD. The method further comprises transmitting a PDCCH monitoring adaptation configuration for a first configured cell and at least a second configured cell to the WD. The method further comprises transmitting, in the first configured cell, an indication to the WD to transit from a first PDCCH monitoring state to a second PDCCH monitoring state in at least the second configured cell.

According to a third aspect, there is a wireless device (WD) configured to communicate with a network node. The WD comprises a radio interface and/or processing circuitry configured to: transmit an intercell physical downlink control channel, PDCCH, monitoring adaptation indication capability information from the WD: receive a PDCCH monitoring adaptation configuration for a first configured cell and at least a second configured cell: receive, in the first configured cell, an indication to transit from a first PDCCH monitoring state to a second PDCCH monitoring state in at least the second configured cell; and responsive to the indication, transit from the first PDCCH monitoring state to the second PDCCH monitoring state in at least the second configured cell.

According to a fourth aspect, there is a network node configured to communicate with a wireless device (WD). The network node comprises a radio interface and/or processing circuitry configured to: receive an intercell physical downlink control channel, PDCCH, monitoring adaptation indication capability information from the WD: transmit a PDCCH monitoring adaptation configuration for a first configured cell and at least a second configured cell to the WD; and transmit, in the first configured cell, an indication to the WD to transit from a first PDCCH monitoring state to a second PDCCH monitoring state in at least the second configured cell.

Advantageously, embodiments of the present invention enable a WD configured with multicell operation to efficiently conduct intercell PDCCH monitoring adaptation such that the WD can obtain better power-saving benefit than in existing systems while keeping the impact on the throughput at a minimum or low.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating example methods implemented in a communication system including a host computer, a network node and a wireless device for executing a client application at a wireless device according to some embodiments of the present disclosure;

FIG. 4 is a flowchart illustrating example methods implemented in a communication system including a host computer, a network node and a wireless device for receiving user data at a wireless device according to some embodiments of the present disclosure;

FIG. 5 is a flowchart illustrating example methods implemented in a communication system including a host computer, a network node and a wireless device for receiving user data from the wireless device at a host computer according to some embodiments of the present disclosure;

FIG. 6 is a flowchart illustrating example methods implemented in a communication system including a host computer, a network node and a wireless device for receiving user data at a host computer according to some embodiments of the present disclosure;

FIG. 7 is a flowchart of an example process in a network node for physical downlink control channel (PDCCH) monitoring adaptation in multicell operations according to some embodiments of the present disclosure; and

FIG. 8 is a flowchart of an example process in a wireless device for physical downlink control channel (PDCCH) monitoring adaptation in multicell operations according to some embodiments of the present disclosure.

### DETAILED DESCRIPTION

Before describing in detail example embodiments, it is noted that the embodiments reside primarily in combinations of apparatus components and processing steps related to physical downlink control channel (PDCCH) monitoring adaptation in multicell operations. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected.” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments advantageously provide methods, systems, and apparatuses for physical downlink control channel (PDCCH) monitoring adaptation in multicell operations.

Some embodiments include methods that can be used for PDCCH monitoring adaptation in the multicell operation. In particular, at least these areas are addressed below:
When the intercell adaptation can be applied;
How the PDCCH monitoring adaptation configuration in a cell should be configured in relation with the PDCCH monitoring adaptation configuration in other cells; and
How the available resources in the DCI can be used to handle intercell adaptation indication.

Some embodiments provide the following method:

A method, implemented in the user equipment (UE), the method comprising:
Transmitting an intercell PDCCH monitoring adaptation indication capability information to the network (NW);
Receiving a PDCCH monitoring adaptation configuration in a first configured cell and in at least a second configured cell;
Receiving an indication in the first cell, indicating at least the second cell, to transit from the first PDCCH monitoring state to the second PDCCH monitoring state; and
Transiting from the first PDCCH monitoring state to the second PDCCH monitoring state, at least in the second configured cell.

Explicit configuration of PDCCH monitoring adaptation behaviors for a cell and a separate field in radio resource control (RRC) for explicit configuration of a downlink control information (DCI) field on the cell for indicating one or more of the PDCCH monitoring adaptation behaviors for the cell, and another separate field in RRC for explicit configuration of another DCI field on a cell for indicating one or more of the PDCCH monitoring adaptation behaviors for another groups of cells are provided.

Some embodiments provide physical downlink control channel (PDCCH) monitoring adaptation in multicell operations. Using one or more methods disclosed in the present disclosure, a WD configured with multicell operation may efficiently conduct intercell adaptation indication, from which the WD could obtain better power-saving benefit than in existing systems while keeping the impact on the throughput at a minimum or low.

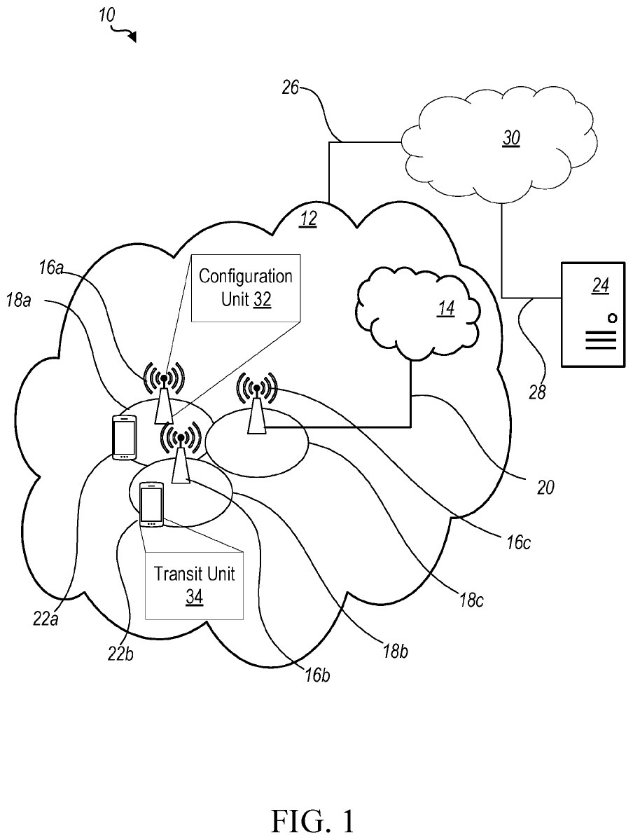

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a. 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a. 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a. 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 may be configured to include a configuration unit 32 which is configured to, responsive to a received indication, cause transmission of a PDCCH monitoring adaptation configuration in a first configured cell and at least a second configured cell to a WD 22. The configuration unit 32 may be further configured to cause transmission, in the first configured cell, of an indication to the WD 22 to transit from a first PDCCH monitoring state to a second PDCCH monitoring state in at least the second configured cell. A wireless device 22 may be configured to include a transit unit 34 which is configured to cause the WD 22 to, responsive to a transit indication, transit from the first PDCCH monitoring state to the second PDCCH monitoring state in at least the second configured cell.

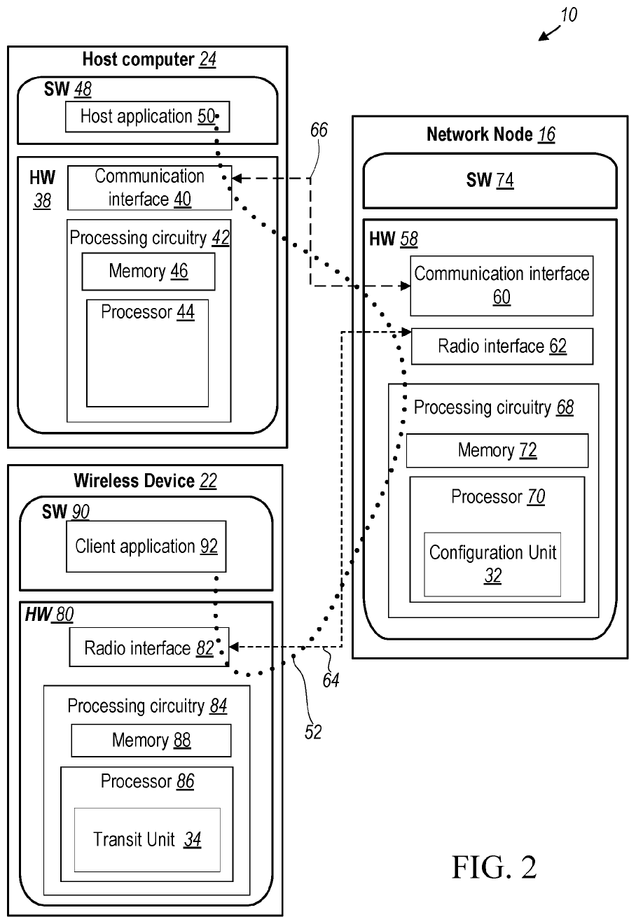

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a configuration unit 32 which is configured to perform one or more network node 16 functions as described herein such as, responsive to a received indication, cause transmission of a PDCCH monitoring adaptation configuration in a first configured cell and at least a second configured cell, and cause transmission, in the first configured cell, of an indication to the WD to transit from a first PDCCH monitoring state to a second PDCCH monitoring state in at least the second configured cell.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a transit unit 34 which is configured to perform one or more WD 22 functions as described herein such as cause the WD 22 to, responsive to a transit indication, transit (e.g., switch, transition, etc.) from the first PDCCH monitoring state to the second PDCCH monitoring state in at least the second configured cell.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes: the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as configuration unit 32, and transit (e.g., transition, switch, change, etc.) unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

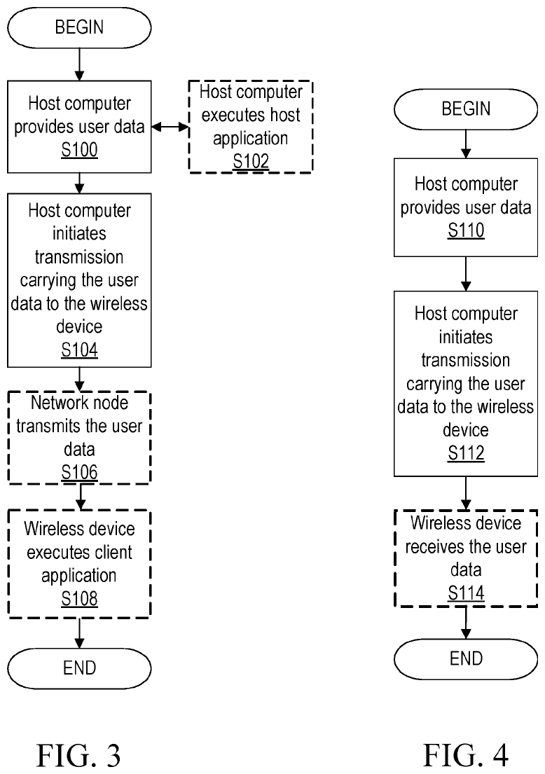

FIG. 3 is a flowchart illustrating an example method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 4 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

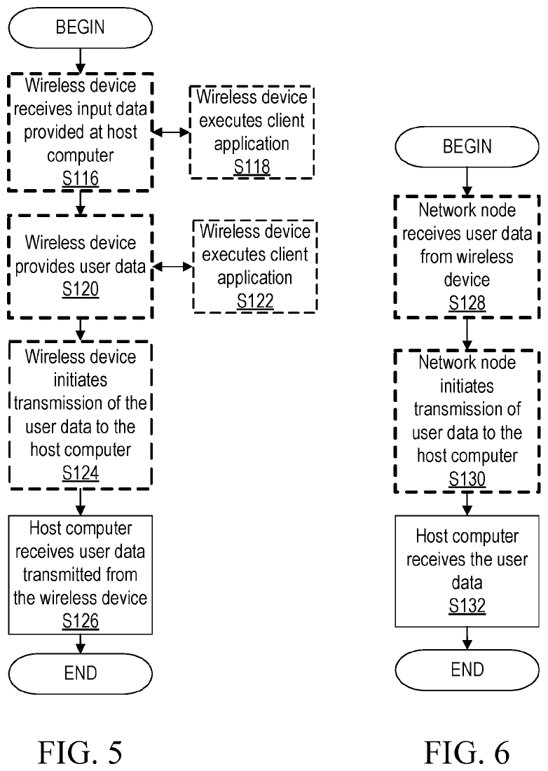

FIG. 5 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

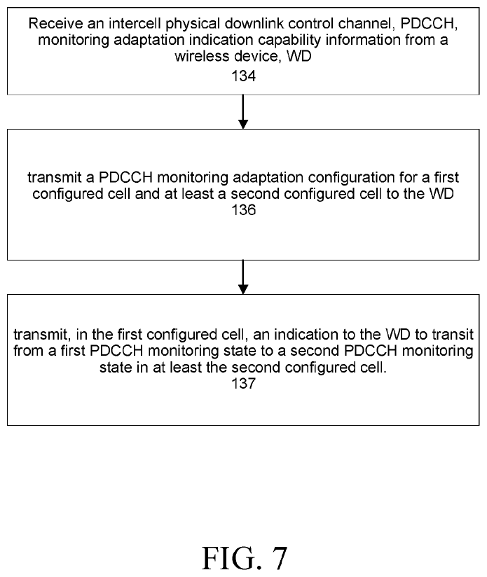

FIG. 7 is a flowchart of an example process in a network node 16 for physical downlink control channel (PDCCH) monitoring adaptation in multicell operations. One or more blocks described herein may be performed by one or more elements of network node 16 such as by one or more of processing circuitry 68 (including the configuration unit 32), processor 70, radio interface 62 and/or communication interface 60. Network node 16 receives an intercell physical downlink control channel, PDCCH, monitoring adaptation indication capability information from the WD (Block 134). The process also includes transmitting a PDCCH monitoring adaptation configuration for a first configured cell and at least a second configured cell to a WD (Block 136); and transmitting, in the first configured cell, an indication to the WD to transit from a first PDCCH monitoring state to a second PDCCH monitoring state in at least the second configured cell (Block 137).

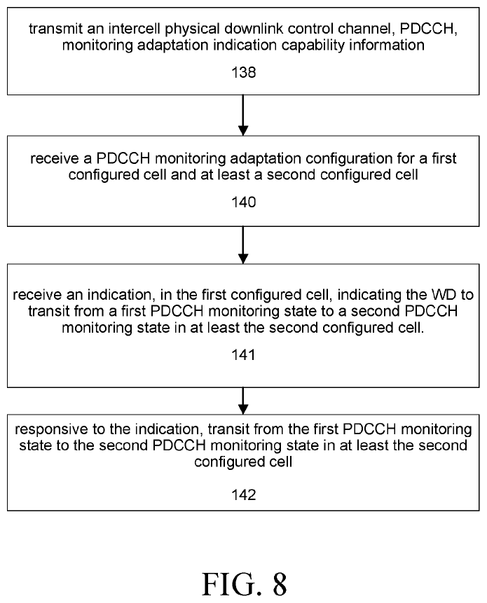

FIG. 8 is a flowchart of an example process in a wireless device 22 according to some embodiments of the present disclosure. One or more blocks described herein may be performed by one or more elements of wireless device 22 such as by one or more of processing circuitry 84 (including the transit unit 34), processor 86, radio interface 82 and/or communication interface 60. Wireless device 22 transmits an intercell physical downlink control channel, PDCCH, monitoring adaptation indication capability information (Block 138). The process also includes receiving a PDCCH monitoring adaptation configuration for a first configured cell and at least a second configured cell (Block 140). The process also includes receiving, in the first configured cell, an indication to transit from a first PDCCH monitoring state to a second PDCCH monitoring state in at least the second configured cell (Block 141). The process also includes, responsive to the indication, transiting from the first PDCCH monitoring state to the second PDCCH monitoring state in at least the second configured cell (Block 142).

Having described the general process flow of arrangements of the disclosure and having provided examples of hardware and software arrangements for implementing the processes and functions of the disclosure, the sections below provide details and examples of arrangements for physical downlink control channel (PDCCH) monitoring adaptation in multicell operations.

A scenario is considered when a WD 22 is capable of supporting a PDCCH monitoring adaptation feature. Here, the PDCCH monitoring adaptation feature includes at least one of or both of SSSG (e.g., search space set switching)-switching and PDCCH-skipping. In some cases, the SSSG switching functionality can be the 3GPP Rel-17 SSSG switching functionality, wherein the SSSG switching can be indicated via a scheduling DCI formats such as 1-1/0-1/1-2/0-2. In SSSG switching, the configuration may include at least one SSSG index for at least one of the configured search space (SS). In PDCCH-skipping, the configuration may include at least a skipping duration.

Beside of the configuration of the PDCCH monitoring adaptation behaviors, the WD 22 may be further configured with a bitfield for PDCCH monitoring adaptation in the DCI, i.e., which can be used as an indication to transit (e.g., transition) from a first PDCCH monitoring state to a second PDCCH monitoring state.

For the self-indication case (e.g., a DCI format sent on cell 1 adapts the WD 22 behavior with respect to PDCCH monitoring on cell 1), up to 2 bits of indication can be configured, e.g., depends on the configuration. In one example, the WD 22 may be configured only with 1 skipping duration, by which the WD 22 is then configured with 1 bit of indication in the DCI (i.e., to represent skipping for a duration of X1 and no-skipping). In another example, the WD 22 may also be configured only with 3 skipping durations, by which the WD 22 is configured with 2 bit of indication (i.e., to represent skipping for a duration of X1, X2, X3, and no-skipping). In yet another example, the WD 22 may be configured with 2 SSSGs or 3 SSSGs, by which the WD 22 is configured respectively with 1 or 2 bits of indication. In yet another example, the WD 22 may be configured with both 2 SSSGs and 1 or 2 skipping duration, by which the WD 22 is configured with 2 bit of indications.

While one or more embodiments have been described with reference to two cells, it should be understood that the embodiments may apply equally to the case of more than 2 cells. In addition, note that the configuration is mentioned per cell, but it should be understood that the configuration may be per bandwidth part (BWP) in the respective cell.

In some embodiments, a method is as follows:
Step 100 Transmitting an intercell PDCCH monitoring adaptation indication capability information to the network (NW)/network node 16;
Step 110 Receiving a PDCCH monitoring adaptation configuration in the first configured cell and in at least second configured cell;
Step 120 Receiving an indication in the first cell, indicating at least the second cell, to transit from the first PDCCH monitoring state to the second PDCCH monitoring state; and/or
Step 130 Transiting from the first PDCCH monitoring state to the second PDCCH monitoring state, at least in the second configured cell.

Of note, the above steps are part of a non-limiting example of an implementation, where teachings described herein may be equally applied to other implementations. Note, as used herein, Blocks are different from Steps.

In Step 100, the WD 22 transmitting a capability information to the NW which indicates that the WD 22 is capable of supporting intercell PDCCH monitoring adaptation indication. In one embodiment, this capability may refer to a capability of at least one of:
The capability of receiving an indication in a first cell, which indicates WD 22 to transit from the first PDCCH monitoring state to the second PDCCH monitoring adaptation state on at least another cell. The capability includes applying the received indication. Note that for the case of the indication, it may be intended for more than one cells (e.g., second and third cells, that may be different from the first cell), and it may be possible that the first and the second PDCCH monitoring states on the second cell may be different from the first and second PDCCH monitoring states on the third cell; and/or
The capability of receiving an indication in the first cell, which indicates the cells, in at least a group of cell(s), to transit from the first PDCCH monitoring state to the second PDCCH monitoring adaptation state and applies the mentioned indication.

Note that, if the WD 22 does not transmit this capability (capability information), the WD 22 may only be indicated with self-indication even when the WD 22 is configured with multiple cells. For example, an indication, received in the first cell may only trigger an adaptation in the first cell; and an indication, received in the second cell may only trigger an adaptation in the second cell, etc.

In Step 110, the WD 22 receives a PDCCH monitoring configuration in the first configured cell and in at least a second configured cell.

The WD 22 may be configured with the second cell with PDCCH monitoring adaptation as the NW or network node 16, for example, may allow the WD 22 to save power while still improving the resources availability, increasing the throughput, etc.

In one embodiment, the configured behaviors of PDCCH monitoring adaptation for the first and the second cells are the same (e.g., the number of configured skipping durations, the number of configured SSSG). In one example, it can be explicitly mentioned in the standard document that the configured parameters in the first cell and in the second cell may be the same. For example, if the first cell is configured only with PDCCH-skipping with 3 skipping durations, the second cell should also be configured only with PDCCH-skipping with 3 skipping durations; and if the first cell is configured with 2 SSSGs and 2 skipping durations where the second cell may also be configured with 2 SSSGs and 2 skipping durations. The parameter, however, may have different values. For example, the first skipping duration configured in the first cell may have a value of 6 ms while the first skipping duration configured in the second cell may have a value of 10 ms. In another example, if the first cell is configured only with PDCCH-skipping with a first number of skipping durations, the second cell is also be configured only with PDCCH-skipping with the first or a second number of skipping durations; and if the first cell is configured with first number of SSSGs and second number of skipping durations, the second cell is also be configured with a third number of SSSGs (which in some cases may be same as the first number) and fourth number of skipping durations (which in some cases may be same as the second number).

An example is shown in Table 1.

For a first cell, up to X behaviors can be configured (e.g., X=4: Switch to SSSG, Switch to a first SSSG, PDCCH Skipping for a first configured duration, No skipping/no switching). The higher layers also indicate via an explicit RRC parameter whether the DCI formats (e.g., one or more of 1-1/1-2/0-1/0-2) on/for the first cell can indicate PDCCH monitoring adaptation for the first cell. The higher layers may indicate (via the same RRC parameter or another one) which of the configured behaviors can be indicated via the DCI formats on the first cell.

For a second cell, up to Y behaviors can be configured (e.g., Y=4: No skipping, skipping for duration X21, skipping for duration X22, skipping for duration X23). The higher layers also indicate via an explicit RRC parameter whether the DCI formats (e.g., one or more of 1-1/1-2/0-1/0-2) on the second cell can indicate PDCCH monitoring adaptation for the second cell. The higher layers may indicate (via the same RRC parameter or another one) which of the configured behaviors can be indicated via the DCI formats on the second cell.

The higher layers also indicate via an explicit RRC parameter whether the DCI formats (e.g., one or more of 1-1/1-2/0-1/0-2) on/for the first cell can indicate PDCCH monitoring adaptation for the second cell (or cells in a group of cells). The higher layers may indicate (via the same RRC parameter or another one) which of the configured behaviors can be indicated via the DCI formats on the first cell.

The first cell can be a primary cell P(S)Cell. The second cell can be secondary serving cell, or a groups of secondary serving cells.

An example is shown in below table 1, which indicates the monitoring adaption states for a first cell, and for a group of cells (second cell and third cell), and the corresponding code points in a first cell's DCI format. A first field may be used for the self-indication, and a second field may be used for the intercell indication, and the first and second fields may be distinct.

TABLE 1

| | | Second CELL | | Third CELL | |
|---|---|---|---|---|---|
| First CELL | | | Order in | | Order in |
| Codepoint | | | the | | the |
| for self- | | | intercell- | | intercell- |
| indication | Interpretation | Interpretation | indication | Interpretation | indication |
| 0 | Switch to | No skipping | 0 | No skipping | 0 |
| | SSSG0 | | | | |
| 1 | Switch to | Skipping for | 1 | Skipping for | 1 |
| | SSSG1 | X21 duration | | X31 duration | |
| 10 | Skipping for | Skipping for | 2 | Skipping for | 2 |
| | X1 duration | X22 duration | | X32 duration | |
| 11 | No | Skipping for | 3 | Skipping for | 3 |
| | skipping/no | X23 duration | | X33 duration | |
| | switching | | | | |

In another embodiment, the configured behaviors for the first and the second cells of PDCCH monitoring adaptation may be required to be the same only when the cells belong to the same group of cell(s). In another example, when the cells belong to the same group of cell(s), the configured parameters for the first and the second cells are same.

Note that when the configured parameters for the first and the second cell of PDCCH monitoring adaptation (and possibly third, fourth, etc.) are the same, the codepoints of the PDCCH monitoring adaptation indication (e.g., in the bitfield of a DCI) are also the same.

In another embodiment, configured behaviors of the PDCCH monitoring adaptation for the first and the second cells may be different. For example, the first cell may be configured with 3 skipping duration while the second cell may be configured with 2 SSSGs and 2 skipping durations. However, this setting may imply that the received indication can be interpreted differently by each cell. Thus, to solve this issue, in a further embodiment, the received PDCCH monitoring adaptation may also contain the order of the PDCCH monitoring adaptation states. The example of this method can be seen in Table 2.

TABLE 2

| SECOND CELL | | | THIRD CELL | | |
|---|---|---|---|---|---|
| | | Order in | | | Order in |
| Codepoint | | the | Codepoint | | the |
| for self- | | intercell- | for self- | | intercell- |
| indication | Interpretation | indication | indication | Interpretation | indication |
| 00 | Switch to SSSG0 | 2 | 0 | No skipping | 0 |
| 01 | Switch to SSSG1 | 3 | 1 | Skipping for X2 | 1 |
| | | | | duration | |
| 10 | Skipping for X1 | 1 | | No adaptation | 2 |
| | duration | | | | |
| 11 | No skipping/no | 0 | | No adaptation | 3 |
| | switching | | | | |

In Table 2, the second cell is configured with 2 SSSGs and 1 skipping duration (X1) while the third cell is configured with 1 skipping duration (X2). The second and the third cell, may for example, belongs to a first group of cell(s). Using the above table, the WD 22 may use individual interpretation when the WD 22 is indicated through a self-scheduling mechanism. The “order in the cell intercell indication” then is used for intercell PDCCH monitoring adaptation indication. For example, the WD 22 may receive an indication in the first cell, indicating the second group of cell(s) to apply PDCCH monitoring adaptation with order number 1. Receiving this indication, the second cell may skip PDCCH monitoring for X1 duration while the third cell may skip PDCCH monitoring for X2 duration. Having this configuration, the interpretation of the indication can be set to be the same, e.g., only different in the parameter values.

In Step 120, the WD 22 receives an indication in the first cell, indicating at least the second cell, to transit from the first PDCCH monitoring state to the second PDCCH monitoring state.

In one embodiment, the indication received in the first cell may individually indicate the transition of the PDCCH monitoring adaptation state in the second cell regardless the group of cell(s). For example, the first cell may belong to the first cell-group while the second cell may belong to the second cell-group. This indication is beneficial, e.g., when a third cell which also belongs to the second cell-group has different expected traffic, i.e., the third cell may need to be indicated to skip PDCCH monitoring often while the second cell, due to more expected traffic, may need to be indicated to skip PDCCH monitoring less often.

In another embodiment, the indication received in the first cell may indicate the adaptation that should be applied by all cells in a group of cell(s). This indication is beneficial, e.g., to minimize the size of the bitfield. For example, the WD 22 operates in both FR1 and FR2 may be configured with a first group of cell(s) containing cells that belong to FR1 and a second group of cell(s) containing cells that belong to FR2.

### DCI Configurations

In one embodiment, two bitfields in a DCI can be configured to represent two approaches intercell adaptation indications. For example, a first bitfield in the first DCI received in the first cell may indicate the PDCCH monitoring adaptation indication for individual cell (e.g., each individual cell); and a second bitfield in the first DCI received in the first cell may indicate the PDCCH monitoring adaptation indication for group of cells.

In another embodiment, two approaches of the intercell adaptation indication can be indicated through different cases of PDCCH monitoring. That is, the first case of a first DCI format may indicate the PDCCH monitoring adaptation indication for group of cells, while the second case of the first DCI format may indicate the PDCCH monitoring adaptation indication for each individual cell.

In one example, the bitfield used for PDCCH monitoring adaptation can be a new bitfield added for PDCCH monitoring adaptation indication. In another example, the bitfield can reuse the existing bitfield. For example, the SCell dormancy indication bitfield can be used for PDCCH monitoring adaptation bitfield, e.g., when the WD 22 is not configured with SCell dormancy feature. This, however, may either significantly increase the size of the bits in the DCI or limit the flexibility of the feature implementation, e.g., the WD 22 cannot be configured with both SCell dormancy and PDCCH monitoring adaptation features. Thus, in a further embodiment, the WD 22 may be configured with a certain RNTI that can be used for PDCCH monitoring adaptation.

In one embodiment, the size of the indication bits for each cell or group of cell(s) may depend on the number of the configured PDCCH monitoring adaptation states. For example, if the second cell (or group of cell(s)) and the third cell (or group of cell(s)) contains 2 and 4 PDCCH monitoring adaptation states to be indicated through intercell (or inter cell-group) adaptation respectively, the size for the second cell (or group of cell(s)) adaptation indication can be 1 while the size for the second (or second cell-group) adaptation indication can be 2.

To optimize the available bits even further, in one embodiment, the intercell (or inter cell-group) adaptation indication may only represent a subset of possible PDCCH monitoring adaptation states of the respected cell. For example, each cell or group of cell(s) may only be indicated via intercell or inter cell-group adaptation indication using 1 bit of indication. The determination of which subset of PDCCH monitoring adaptation state that can be indicated via intercell or inter cell-group adaptation indication can be based on the order number that is configured for the WD 22 (e.g., as in Table 1). For example, the intercell (or inter cell-group) adaptation may only indicate the first two PDCCH monitoring adaptation states configured for the WD 22. In one example, the number of bits available for each cell or group of cell(s) may be configurable, e.g., one or two bits. However, the number of bits available for the overall adaptation may be predefined. Thus, in one example of implementation, the number of bits available for each cell or group of cell(s) may depend on the number of cell or group of cell(s) configured for the WD 22. For example, a maximum of 4 bits is available for inter cell-group PDCCH monitoring adaptation. If the WD 22 is configured with 4 group of cell(s), then each group of cell(s) will have 1 bit for inter cell-group adaptation indication. However, if the WD 22 is configured with 2 group of cell(s), up to 2 bits can be used for inter cell-group adaptation indication.

In Step 130, the WD 22 transits from the first PDCCH monitoring state to the second PDCCH monitoring state, at least in the second cell after receiving the indication. Note that in transiting to the second PDCCH monitoring adaptation states, a certain application delay may also apply.

The WD 22 may be configured with X (up to 4) different PDCCH monitoring behaviors per cell. Each behavior can be one of the following: PDCCH skipping is not activated/applied, PDCCH skipping for an indicated duration, and PDCCH monitoring according an indicated SSSG.

For self-scheduling, the number of bits in the bitfield is explicitly configured based on the RRC.

For cross-carrier indication the number of bits can be less (e.g., 1 bit per cell group) based on the subset of possible behaviors. The subset of the behaviors, e.g., can be explicitly configured in RRC.

In some cases, it is allowed to only configure with self-scheduling indication only, cross-scheduling indication only or both.

In one example embodiment (Example E1):
For a first serving cell, WD 22 can be configured with higher layer parameters indicating one or more PDCCH skipping durations. For example, a first skipping duration of X11 slots/OFDM-symbols/milli-seconds (the slots/symbols can be based on a SCS configuration of the first serving cell). For same-cell PDCCH monitoring adaptation (i.e., the indication for PDCCH monitoring adaptation for a given cell is provided using layer 1 signaling, e.g., PDCCH received on that cell) WD 22 can be provided with a one bit DCI indication (e.g., in DCI format 0_1 or 1_1) indicating whether to skip for X11 duration or not;
For a second serving cell, WD 22 can be also configured with higher layer parameters indicating one or more PDCCH skipping durations. For example, three skipping durations X21, X22, X23 slots/OFDM-symbols/milli-seconds (the slots/symbols can be based on a SCS configuration of the second serving cell). For same-cell PDCCH monitoring adaptation, WD 22 can be provided with a two bit DCI indication (e.g., in DCI format 0_1 or 1_1) indicating whether to skip for one of X11, X22, X23 durations or no skipping;
For a third serving cell, WD 22 can be also configured with higher layer parameters indicating one or more PDCCH skipping durations. For example, three skipping durations X31, X32, X33 slots/OFDM-symbols/milli-seconds (the slots/symbols can be based on a SCS configuration of the second serving cell). For same-cell PDCCH monitoring adaptation WD 22 can be provided with a two bit DCI indication (e.g., in DCI format 0_1 or 1_1) indicating whether to skip for one of X31, X32, X33 durations or no skipping;
For cross-cell (or intercell) PDCCH monitoring adaptation (i.e., the indication for PDCCH monitoring adaptation for a given cell is provided using layer 1 signaling, e.g., PDCCH received on another cell), for example, for a cross-cell indication received on first serving cell indicating PDCCH monitoring adaptation for second and third serving cells, WD 22 can be provided one DCI bit each for each of the second and third serving cells. The bit corresponding to second serving cell can indicate whether to skip X21 or no skipping. X21, for example, can be the first duration in the list of durations (X21, X22, X23) configured by higher layers. Alternately, higher layers may indicate X21 as a default duration or explicitly indicate that X21 is to be used for cross-cell adaptation. Similarly, the one bit corresponding to third serving cell can indicate whether to skip for X31 or no skipping. More generally, the number of bit(s) used for cross-cell indication for a given serving cell can be smaller than the number of bits used for same-cell indication for that serving cell;
   For cross cell indication, WD 22 can alternately receive a higher layer indication that second and third cells belong to a group (e.g., G0), then instead of one bit each for the second and third serving cells (i.e., two bits in total), the WD 22 can be provided with a single bit indication that is applicable to all cells within the group G0.

For the above example E1 (E1), instead of being configured with multiple skipping durations for a given serving cell (e.g., one or more of the first, second, third serving cells discussed above for E1), in some cases, WD 22 can be configured with multiple search space set groups (SSSGs). For example, a first set of PDCCH monitoring search space sets are associated via higher layer signaling with a first SSSG (SSSG0) and a second set of search space sets are associated with a second SSSG (SSSG1). The same-cell PDCCH monitoring adaptation indication or the cross-cell PDCCH monitoring adaptation indication discussed above can then indicate the WD 22 to monitor PDCCH search space sets belonging to either SSG0 or SSSG1 for the given serving cell.

For the above example E1, the WD 22 may be configured with one or more skipping durations and also multiple SSSGs using for a given serving cell (e.g., one or more of the first, second, third serving cells discussed above for E1). The same-cell PDCCH monitoring adaptation indication or the cross-cell PDCCH monitoring adaptation indication discussed above can then indicate the WD 22 to monitor PDCCH search space sets belonging to a particular SSSG or skip PDCCH monitoring for a preconfigured duration.

According to one aspect, network node 16 is configured to communicate with a wireless device (WD) 22. The network node 16 includes a radio interface 62 and/or comprises processing circuitry 68 configured to: receive an intercell physical downlink control channel, PDCCH, monitoring adaptation indication capability information from the WD 22; transmit a PDCCH monitoring adaptation configuration for a first configured cell and at least a second configured cell to the WD 22; and transmit, in the first configured cell, an indication to the WD 22, indicating the WD 22 to transit from a first PDCCH monitoring state to a second PDCCH monitoring state in at least the second configured cell.

The network node 16 may be configured to, responsive to the received capability information: transmit a PDCCH monitoring adaptation configuration for a first configured cell and at least a second configured cell to the WD 22; and transmit, in the first configured cell, an indication to the WD 22 to transit from a first PDCCH monitoring state to a second PDCCH monitoring state in at least the second configured cell.

The first configured cell may be a Primary Cell, PCell. The second configured cell may be a Secondary cell or a group of Secondary cells.

In some embodiments, the PDCCH monitoring adaption configuration for the second configured cell may be the same as the PDCCH monitoring adaption behavior configuration for the first configured cell. In this case, the first configured cell and the second cell may belong to a same group of cells.

In other embodiments, the PDCCH monitoring adaption configuration for the second configured cell may be different from the PDCCH monitoring adaption configuration for the first configured cell. For example, the PDCCH monitoring adaption configuration for the first configured cell may comprise one or more PDCCH monitoring configuration parameters. The PDCCH monitoring adaption configuration for the second configured cell may comprise the same one or more PDCCH monitoring configuration parameters but set to different values from the one or more PDCCH monitoring configuration parameters for the first configured cell. In addition or alternatively, the PDCCH monitoring adaption configuration for the second configured cell may comprise different and/or a different number of PDCCH monitoring adaption configuration parameters than the PDCCH monitoring adaption configuration for the first configured cell. For example, the PDCCH monitoring adaption configuration for the second configured cell may comprise fewer PDCCH monitoring adaption configuration parameters than the PDCCH monitoring adaption configuration for the first configured cell.

The network node 16 may further be configured to transmit a PDCCH monitoring adaption configuration for a third configured cell to the WD 22; wherein the indication on the first configured cell may further indicate the WD 22 to transit from a first PDCCH monitoring state to a second PDCCH monitoring state in at least the third configured cell. At least one of the first PDCCH monitoring state and the second PDCCH monitoring state for the third configured cell may be different from the first PDCCH monitoring state and the second PDCCH monitoring state respectively for the second configured cell. This may be so, even though the second and third cells belong to a same group of cells.

The PDCCH monitoring adaptation configuration for the first and/or second and/or third configured cell may include at least one of search space set SSSG switching and PDCCH skipping parameters.

The network node 16 may be configured to transmit the PDCCH monitoring adaption configuration in Radio Resource Control, RRC, signaling.

The network node 16 may be configured to transmit the indication in a DCI field in a downlink control information, DCI, on the first configured cell.

The PDCCH monitoring adaption configuration may comprise a parameter indicating whether a DCI on the first configured cell can indicate a PDCCH monitoring adaption for at least the second configured cell.

The PDCCH monitoring adaption configuration may further indicate which of one or more PDCCH monitoring configuration parameters for the second configured cell can be indicated via the DCI field on the first configured cell. In this case, the one or more PDCCH monitoring configuration parameters which can be indicated via the DCI field on the first configured cell may be a subset of the configured PDCCH monitoring configuration parameters for the second configured cell.

The PDCCH monitoring adaption configuration may configure the WD 22 to associate the indication with different PDCCH monitoring configuration parameters for the second and third configured cells respectively.

The DCI on the first configured cell may further comprises a self-indication indicating the WD 22 to adapt the WD 22 behavior with respect to PDCCH monitoring on the first configured cell. The DCI on the first configured cell may comprise a first field for the self-indication; wherein the DCI field comprising the indication is distinct from the first field. The number of bits representing the indication may be fewer than the number of bits representing the self-indication.

In some embodiments, the DCI field comprising the indication can alternatively be used for a SCell dormancy indication.

In other embodiments, the network node 16 may be configured to use a specific Radio Network Temporary Indicator, RNTI, to indicate that the DCI field contains the indication.

According to another aspect, a method implemented in a network node 16 is provided. The method includes receiving an intercell physical downlink control channel, PDCCH, monitoring adaptation indication capability information from a WD 22; transmitting a PDCCH monitoring adaptation configuration for a first configured cell and at least a second configured cell to the WD 22; and transmitting, in/on the first configured cell, an indication to the WD 22 to transit from a first PDCCH monitoring state to a second PDCCH monitoring state in at least the second configured cell.

The method may further comprise, responsive to the received capability information: transmitting a PDCCH monitoring adaptation configuration for a first configured cell and at least a second configured cell to the WD 22; and transmitting, in the first configured cell, an indication to the WD 22 to transit from a first PDCCH monitoring state to a second PDCCH monitoring state in at least the second configured cell.

The first configured cell may be a Primary Cell, PCell. The second configured cell may be a Secondary cell or a group of Secondary cells.

In some embodiments, the PDCCH monitoring adaption configuration for the second configured cell may be the same as the PDCCH monitoring adaption behavior configuration for the first configured cell. In this case, the first configured cell and the second cell may belong to a same group of cells.

In other embodiments, the PDCCH monitoring adaption configuration for the second configured cell may be different from the PDCCH monitoring adaption configuration for the first configured cell. The PDCCH monitoring adaption configuration for the first configured cell may comprise one or more PDCCH monitoring configuration parameters. The PDCCH monitoring adaption configuration for the second configured cell may comprise the same one or more PDCCH monitoring configuration parameters but set to different values from the one or more PDCCH monitoring configuration parameters for the first configured cell. In addition or alternatively, the PDCCH monitoring adaption configuration for the second configured cell may comprise different and/or a different number of PDCCH monitoring adaption configuration parameters than the PDCCH monitoring adaption configuration for the first configured cell. For example, the PDCCH monitoring adaption configuration for the second configured cell may comprise fewer PDCCH monitoring adaption configuration parameters than the PDCCH monitoring adaption configuration for the first configured cell.

The method may further comprise transmitting a PDCCH monitoring adaption configuration for a third configured cell to the WD 22: wherein the indication in the first configured cell may further indicate the WD 22 to transit from a first PDCCH monitoring state to a second PDCCH monitoring state in at least the third configured cell. At least one of the first PDCCH monitoring state and the second PDCCH monitoring state for the third configured cell may be different from the first PDCCH monitoring state and the second PDCCH monitoring state for the second configured cell respectively. This may be so, even though the second and third cells belong to a same group of cells.

The PDCCH monitoring adaptation configuration for the first and/or second and/or third configured cell may include at least one of search space set SSSG switching and PDCCH skipping parameters.

The PDCCH monitoring adaption configuration may be transmitted in Radio Resource Control, RRC, signaling.

The indication may be transmitted in a DCI field in a downlink control information, DCI, on the first configured cell.

The PDCCH monitoring adaption configuration may comprise a parameter indicating whether a DCI on the first configured cell can indicate a PDCCH monitoring adaption for at least the second configured cell.

The PDCCH monitoring adaption configuration may further indicate which of one or more PDCCH monitoring configuration parameters for the second configured cell can be indicated via the DCI field on the first configured cell. In this case, the one or more PDCCH monitoring configuration parameters which can be indicated via the DCI field on the first configured cell may be a subset of the configured PDCCH monitoring configuration parameters for the second configured cell.

The PDCCH monitoring adaption configuration may configure the WD 22 to associate the indication with different PDCCH monitoring configuration parameters for the second and third configured cells respectively.

The DCI on the first configured cell may further comprises a self-indication indicating the WD to adapt the WD 22 behavior with respect to PDCCH monitoring on the first configured cell. The DCI on the first configured cell may comprise a first field for the self-indication; wherein the DCI field comprising the indication is distinct from the first field. The number of bits representing the indication may be fewer than the number of bits representing the self-indication.

In some embodiments, the DCI field comprising the indication can alternatively be used for a SCell dormancy indication.

In other embodiments, the method may comprise using a specific RNTI to indicate that the DCI field contains the indication.

According to yet another aspect, a wireless device (WD) 22 is configured to communicate with a network node 16. The WD 22 includes a radio interface 82 and/or processing circuitry 84 configured to: transmit an intercell physical downlink control channel, PDCCH, monitoring adaptation indication capability information; receive a PDCCH monitoring adaptation configuration for a first configured cell and at least a second configured cell; and receive an indication, on the first configured cell, to transit from a first PDCCH monitoring state to a second PDCCH monitoring state in at least the second configured cell; and responsive to the indication, transit from the first PDCCH monitoring state to the second PDCCH monitoring state in at least the second configured cell.

The first configured cell may be a Primary Cell, PCell. The second configured cell may be a Secondary cell or a group of Secondary cells.

In some embodiments, the PDCCH monitoring adaption configuration for the second configured cell may be the same as the PDCCH monitoring adaption behavior configuration for the first configured cell. In this case, the first configured cell and the second cell may belong to a same group of cells.

In other embodiments, the PDCCH monitoring adaption configuration for the second configured cell may be different from the PDCCH monitoring adaption configuration for the first configured cell. The PDCCH monitoring adaption configuration for the first configured cell may comprise one or more PDCCH monitoring configuration parameters. The PDCCH monitoring adaption configuration for the second configured cell may comprise the same one or more PDCCH monitoring configuration parameters but set to different values from the one or more PDCCH monitoring configuration parameters for the first configured cell. In addition or alternatively, the PDCCH monitoring adaption configuration for the second configured cell may comprise different and/or a different number of PDCCH monitoring adaption configuration parameters than the PDCCH monitoring adaption configuration for the first configured cell. For example, the PDCCH monitoring adaption configuration for the second configured cell may comprise fewer PDCCH monitoring adaption configuration parameters than the PDCCH monitoring adaption configuration for the first configured cell.

The WD 22 may further be configured to receive a PDCCH monitoring adaption configuration for a third configured cell; wherein the indication in the first configured cell may further indicate the WD 22 to transit from a first PDCCH monitoring state to a second PDCCH monitoring state in at least the third configured cell. At least one of the first PDCCH monitoring state and the second PDCCH monitoring state for the third configured cell may be different from the first PDCCH monitoring state and the second PDCCH monitoring state for the second configured cell. This may be so, even though the second and third cells belong to a same group of cells.

The PDCCH monitoring adaptation configuration for the first and/or second and/or third configured cell may include at least one of search space set SSSG switching and PDCCH skipping parameters.

The WD 22 may be configured to receive the PDCCH monitoring adaption configuration in Radio Resource Control, RRC, signaling.

The WD 22 may be configured to receive the indication in a DCI field in a downlink control information, DCI, on the first configured cell.

The PDCCH monitoring adaption configuration may comprise a parameter indicating whether a DCI on the first configured cell can indicate a PDCCH monitoring adaption for at least the second configured cell.

The PDCCH monitoring adaption configuration may further indicate which of one or more PDCCH monitoring configuration parameters for the second configured cell can be indicated via the DCI field on the first configured cell. In this case, the one or more PDCCH monitoring configuration parameters which can be indicated via the DCI field on the first configured cell may be a subset of the configured PDCCH monitoring configuration parameters for the second configured cell.

The PDCCH monitoring adaption configuration may configure the WD 22 to associate the indication with different PDCCH monitoring configuration parameters for the second and third configured cells respectively.

The DCI on the first configured cell may further comprises a self-indication indicating the WD 22 to adapt the WD 22 behavior with respect to PDCCH monitoring on the first configured cell. The DCI on the first configured cell may comprise a first field for the self-indication; wherein the DCI field comprising the indication is distinct from the first field. The number of bits representing the indication may be fewer than the number of bits representing the self-indication.

In some embodiments, the DCI field comprising the indication can alternatively be used for a SCell dormancy indication.

In other embodiments, the WD 22 may be configured with a specific RNTI indicating that the DCI field contains the indication.

According to another aspect, a method implemented in a wireless device (WD) 22 is provided. The method includes transmitting an intercell physical downlink control channel, PDCCH, monitoring adaptation indication capability information; receiving a PDCCH monitoring adaptation configuration for a first configured cell and at least a second configured cell; receiving an indication, in the first configured cell, to transit from a first PDCCH monitoring state to a second PDCCH monitoring state in at least the second configured cell; and responsive to the indication, transiting from the first PDCCH monitoring state to the second PDCCH monitoring state in at least the second configured cell.

The first configured cell may be a Primary Cell, PCell. The second configured cell may be a Secondary cell or a group of Secondary cells.

In some embodiments, the PDCCH monitoring adaption configuration for the second configured cell may be the same as the PDCCH monitoring adaption behavior configuration for the first configured cell. In this case, the first configured cell and the second cell may belong to a same group of cells.

In other embodiments, the PDCCH monitoring adaption configuration for the second configured cell may be different from the PDCCH monitoring adaption configuration for the first configured cell. The PDCCH monitoring adaption configuration for the first configured cell may comprise one or more PDCCH monitoring configuration parameters. The PDCCH monitoring adaption configuration for the second configured cell may comprise the same one or more PDCCH monitoring configuration parameters but set to different values from the one or more PDCCH monitoring configuration parameters for the first configured cell. In addition or alternatively, the PDCCH monitoring adaption configuration for the second configured cell may comprise different and/or a different number of PDCCH monitoring adaption configuration parameters than the PDCCH monitoring adaption configuration for the first configured cell. For example, the PDCCH monitoring adaption configuration for the second configured cell may comprise fewer PDCCH monitoring adaption configuration parameters than the PDCCH monitoring adaption configuration for the first configured cell.

The method may further comprise receiving a PDCCH monitoring adaption configuration for a third configured cell. The indication in the first configured cell may further indicate the WD to transit from a first PDCCH monitoring state to a second PDCCH monitoring state in at least the third configured cell. Furthermore, in some embodiments, at least one of the first PDCCH monitoring state and the second PDCCH monitoring state for the third configured cell may be different from the first PDCCH monitoring state and the second PDCCH monitoring state for the second configured cell respectively. This may be so, even though the second and third cells belong to a same group of cells.

The PDCCH monitoring adaptation configuration for the first and/or second and/or third configured cell may include at least one of search space set SSSG switching and PDCCH skipping parameters.

The PDCCH monitoring adaption configuration may be received in RRC signaling.

The indication may be received in a DCI field in a downlink control information, DCI, received on the first configured cell.

The PDCCH monitoring adaption configuration may comprise a parameter indicating whether a DCI on the first configured cell can indicate a PDCCH monitoring adaption for at least the second configured cell.

The PDCCH monitoring adaption configuration may further indicate which of one or more PDCCH monitoring configuration parameters for the second configured cell can be indicated via the DCI field on the first configured cell. In this case, the one or more PDCCH monitoring configuration parameters which can be indicated may be a subset of the configured PDCCH monitoring configuration parameters for the second configured cell.

The PDCCH monitoring adaption configuration may configure the WD to associate the indication with different PDCCH monitoring configuration parameters for the second and third configured cells respectively.

The DCI on the first configured cell may further comprises a self-indication indicating the WD 22 to adapt the WD 22 behavior with respect to PDCCH monitoring on the first configured cell. The DCI on the first configured cell may comprise a first field for the self-indication; wherein the DCI field comprising the indication is distinct from the first field. The number of bits representing the indication may be fewer than the number of bits representing the self-indication.

In some embodiments, the DCI field comprising the indication can alternatively be used for a SCell dormancy indication.

In other embodiments, the WD 22 may be configured with a specific RNTI indicating that the DCI field contains the indication.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings.

1. A method implemented in a wireless device (WD), the method comprising:
transmitting an intercell physical downlink control channel, PDCCH, monitoring adaptation indication capability information;
receiving a PDCCH monitoring adaptation configuration for a first configured cell and at least a second configured cell;
receiving an indication, in the first configured cell, indicating the WD to transit from a first PDCCH monitoring state to a second PDCCH monitoring state in at least the second configured cell; and
responsive to the indication, transiting from the first PDCCH monitoring state to the second PDCCH monitoring state in at least the second configured cell.

2. The method according to claim 1, wherein the first configured cell is a Primary Cell, PCell.

3. The method according to claim 1, wherein the second configured cell is a Secondary cell or a group of Secondary cells.

4. The method according to claim 1, wherein the PDCCH monitoring adaption configuration for the second configured cell is the same as the PDCCH monitoring adaption behavior configuration for the first configured cell.

5. (canceled)

6. The method according to claim 1, wherein the PDCCH monitoring adaption configuration for the second configured cell is different from the PDCCH monitoring adaption configuration for the first configured cell.

7. The method according to claim 6, wherein the PDCCH monitoring adaption configuration for the first configured cell comprises one or more PDCCH monitoring configuration parameters; and wherein the PDCCH monitoring adaption configuration for the second configured cell comprises the same one or more PDCCH monitoring configuration parameters but set to different values from the one or more PDCCH monitoring configuration parameters for the first configured cell.

8. The method according to claim 6, wherein the PDCCH monitoring adaption configuration for the second configured cell comprises different and/or a different number of PDCCH monitoring adaption configuration parameters than the PDCCH monitoring adaption configuration for the first configured cell.

9. The method according to claim 8, wherein the PDCCH monitoring adaption configuration for the second configured cell comprises fewer PDCCH monitoring adaption configuration parameters than the PDCCH monitoring adaption configuration for the first configured cell.

10.-13. (canceled)

14. The method according to claim 1, wherein the PDCCH monitoring adaptation configuration for the first and/or second configured cell includes at least one of search space set SSSG switching and PDCCH skipping parameters.

15. The method of claim 1, wherein the PDCCH monitoring adaption configuration is received in Radio Resource Control, RRC, signaling.

16. The method of claim 1, wherein the indication is received in a DCI field in a downlink control information, DCI, received on the first configured cell.

17. The method according to claim 16, wherein the PDCCH monitoring adaption configuration comprises a parameter indicating whether a DCI on the first configured cell can indicate a PDCCH monitoring adaption for at least the second configured cell.

18.-20. (canceled)

21. The method according to claim 16, wherein the DCI on the first configured cell further comprises a self-indication indicating the WD to adapt the WD behavior with respect to PDCCH monitoring on the first cell; and
wherein the DCI on the first configured cell comprises a first field for the self-indication;
wherein the DCI field comprising the indication is distinct from the first field.

22. (canceled)

23. The method according to claim 21, wherein the number of bits representing the indication is fewer than the number of bits representing the self-indication.

24. The method according to claim 16, wherein the DCI field comprising the indication can alternatively be used for a SCell dormancy indication.

25. The method according to claim 16, wherein the WD is configured with a specific Radio Network Temporary Indicator, RNTI, indicating that the DCI field contains the indication.

26. A method implemented in a network node, the method comprising:
receiving an intercell physical downlink control channel, PDCCH, monitoring adaptation indication capability information from a wireless device, WD;
transmitting a PDCCH monitoring adaptation configuration for a first configured cell and at least a second configured cell to the WD; and
transmitting, in the first configured cell, an indication to the WD to transit from a first PDCCH monitoring state to a second PDCCH monitoring state in at least the second configured cell.

27.-36. (canceled)

37. A wireless device (WD) configured to communicate with a network node, the WD comprising one or both of a radio interface and processing circuitry configured to:
transmit an intercell physical downlink control channel, PDCCH, monitoring adaptation indication capability information from the WD;
receive a PDCCH monitoring adaptation configuration for a first configured cell and at least a second configured cell,
receive, in the first configured cell, an indication to transit from a first PDCCH monitoring state to a second PDCCH monitoring state in at least the second configured cell; and
responsive to the indication, transit from the first PDCCH monitoring state to the second PDCCH monitoring state in at least the second configured cell.

38. A wireless device (WD) according to claim 37, wherein the first configured cell is a Primary Cell, PCell.

39. A network node configured to communicate with a wireless device (WD), the network node comprising a radio interface and/or processing circuitry configured to:
receive an intercell physical downlink control channel, PDCCH, monitoring adaptation indication capability information from the WD;
transmit a PDCCH monitoring adaptation configuration for a first configured cell and at least a second configured cell to the WD; and
transmit, in the first configured cell, an indication to the WD to transit from a first PDCCH monitoring state to a second PDCCH monitoring state in at least the second configured cell.

40. (canceled)
